(19) United States
(12) Patent Application Publication
(10) Pub. No.: US 2014/0023192 A1
(43) Pub. Date: Jan. 23, 2014

(54) COMMUNICATION DEVICE, COMMUNICATION METHOD, AND COMMUNICATION SYSTEM

(71) Applicant: Kabushiki Kaisha Toshiba, (US)

(72) Inventors: Yoshimichi TANIZAWA, Kanagawa (JP); Shinichi BABA, Bristol (GB)

(21) Appl. No.: 13/834,559

(22) Filed: Mar. 15, 2013

(30) Foreign Application Priority Data
Jul. 17, 2012 (JP) 2012-159044

(51) Int. Cl. H04L 9/08

(52) U.S. Cl. CPC H04L 9/0861
USPC 380/44

(57) ABSTRACT

According to an embodiment, a communication device is connected to a key generating device which generates an encryption key. The communication device includes an obtaining unit and a calculator. The obtaining unit is configured to obtain key resource information which indicates a resource of the encryption key that can be provided by the key generating device. The calculator is configured to, based on the obtained key resource information, calculate the key resource information of the encryption key that can be provided to an application which makes use of the encryption key.

### CROSS-REFERENCE TO RELATED APPLICATIONS

This application is based upon and claims the benefit of priority from Japanese Patent Application No. 2012-159044, filed on Jul. 17, 2012; the entire contents of which are incorporated herein by reference.

### FIELD

An embodiment described herein relates generally to a communication device, a communication method, and a communication system.

### BACKGROUND

A cryptographic communication network is known that is configured with a plurality of networked nodes which is mutually connected by a plurality of links. Each node has the function of generating and sharing a random number with opposite nodes that are connected by links, as well as has the function of performing cryptographic communication over a link by using the random number as a cryptographic key (hereinafter, referred to as “a link key”). Moreover, some of the nodes also have the function of generating a random number independent of the links, as well as have the function of sending the generated random number to a different node. In a cryptographic communication network, an application has the function of obtaining a random number from a node, using the random number as a cryptographic key (hereinafter, referred to as “an application key”), and performing cryptographic communication with another application. Herein, an application can be configured in an integrated manner with the nodes, or can be configured as a terminal independent of the nodes.

In a node, the function by which a random number (a link key) is generated and shared with opposite nodes connected by links can be implemented using a technology that is commonly called quantum cryptographic communication. In this case, the technology by which, in a node, a random number (an application key) is generated independent of the links and sent to a different node via a link may be called quantum key distribution (QKD).

However, in the conventional technology, it is not clear what kind of sequence an application follows to obtain the information regarding application keys obtainable from a node. For that reason, for example, the application becomes unable to determine an appropriate encryption algorithm in accordance with the obtainable application keys.

### BRIEF DESCRIPTION OF THE DRAWINGS

FIG. 1 is a diagram illustrating a network configuration example of a communication system according to an embodiment;

FIG. 2 is a diagram for explaining an exemplary use case that is assumed in the embodiment;

FIG. 3 is a block diagram illustrating a configuration example of a node according to the embodiment;

FIG. 4 is a block diagram illustrating a configuration example of an application according to the embodiment;

FIG. 5 is a flowchart for explaining a key resource calculation operation according to the embodiment;

FIG. 6 is a diagram illustrating a network configuration example of the communication system according to the embodiment;

FIG. 7 is a diagram illustrating a network configuration example of the communication system according to the embodiment; and

FIG. 8 is an explanatory diagram for explaining a hardware configuration of devices according to the embodiment.

### DETAILED DESCRIPTION

According to an embodiment, a communication device is connected to a key generating device which generates an encryption key. The communication device includes an obtaining unit and a calculator. The obtaining unit is configured to obtain key resource information which indicates a resource of the encryption key that can be provided by the key generating device. The calculator is configured to, based on the obtained key resource information, calculate the key resource information of the encryption key that can be provided to an application which makes use of the encryption key.

Embodiments will be described below in detail with reference to the accompanying drawings.

Depending on the type thereof, a communication device (an application) needs to have, prior to starting communication (cryptographic communication), the information regarding how many application keys are obtainable from a key generating device (a node). For example, an application that performs video communication or audio communication in which data communication is carried out on an continuous basis may query, prior to starting the communication, about whether or not it is possible to obtain application keys equal to or greater than a certain quantity from a node on a continuous basis and may accordingly determine the usable band or the encryption algorithm. Moreover, for example, a file transfer application that transfers a large file at once may query, prior to starting the communication, whether it is possible to promptly obtain a sufficient quantity of application keys in order to transfer the large file at once.

Thus, there are times when an application requires, from a node, the information regarding the key generation speed (throughput) for generating usable application keys or information regarding the key retention quantity of application keys. In the following explanation, the application key resource, such as the key generation speed or the key retention quantity of application keys, that a node can provide is referred to as key resource information or simply as a key resource. Moreover, the key resource information is not limited to the key generation speed or the key retention quantity of application keys. Furthermore, the configuration can be such that a value obtained by performing a weighted-addition of a plurality of pieces of key resource information (such as the key generation speed or the key retention quantity) is used as the key resource information.

Meanwhile, for a node to send back the key resource such as the key generation speed or the key retention quantity, the node needs to take into account not only the information about application keys held therein but also the information about application keys held in other nodes, the information about link keys, and the information about other applications.

Therefore, in the embodiment, with the aim of sending back and allotting a key resource to an application, light is shed on the method of calculating a key resource, managing the key resource, and allotting the key resource to an application. A communication system according to the embodiment has, for example, the following configuration.

In response to a query about the key resource from an application; a node calculates, manages, and allots a key resource by implementing the following method.
(A1) gathering of the key resource information
(A2) gathering of the information about other applications
(A3) calculation of path candidates
(A4) determination of the most suitable path and determination of response to the application

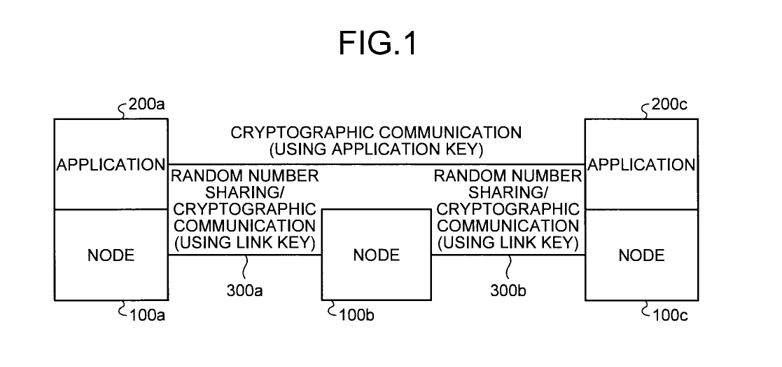

FIG. 1 is a diagram illustrating a network configuration example of the communication system according to the embodiment. The communication system includes nodes 100a to 100c, which function as key generating devices, and includes applications 200a and 200c, which function as communication devices.

When there is no need to distinguish between the nodes 100a to 100c, they are simply referred to as nodes 100. Similarly, when there is no need to distinguish between the applications 200a and 200c, they are simply referred to as applications 200. Meanwhile, the number of nodes 100 is not limited to three, and the number of applications 200 is not limited to two.

Each of the nodes 100a to 100c has the function of generating and sharing a random number with opposite nodes and has the function of performing cryptographic communication over links (links 300a and 300b) by using the random number as a link key. Moreover, each node 100 can also have the function of generating a random number independent of the links, and the function of sending the generated random number to a different node.

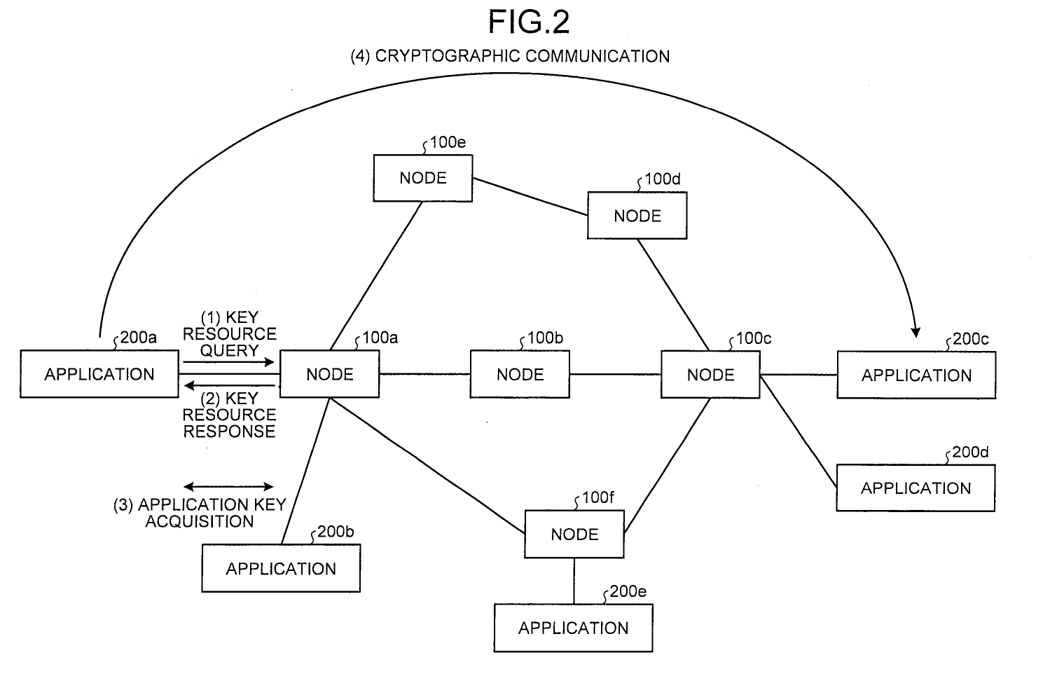

FIG. 2 is a diagram for explaining an exemplary use case that is assumed in the embodiment. Given below is the explanation of the use case illustrated in FIG. 2.

It is assumed that the application 200a that is connected to the node 100a starts communication with the application 200c that is connected to the node 100c. At that time, the following operations from (1) to (4) are performed.
(1) key resource query: the application 200a sends a query to the node 100a about the key resource that can be used at the time of communicating with the application 200c
(2) key resource response: in response to the query, the node 100a sends the information about the usable key resource to the application 200a
(3) application key acquisition: the application 200a requests the node 100a for application keys and obtains the application keys from the node 100a
(4) cryptographic communication: the application 200a performs cryptographic communication with the application 200c by making use of the application keys that are obtained from the node 100a

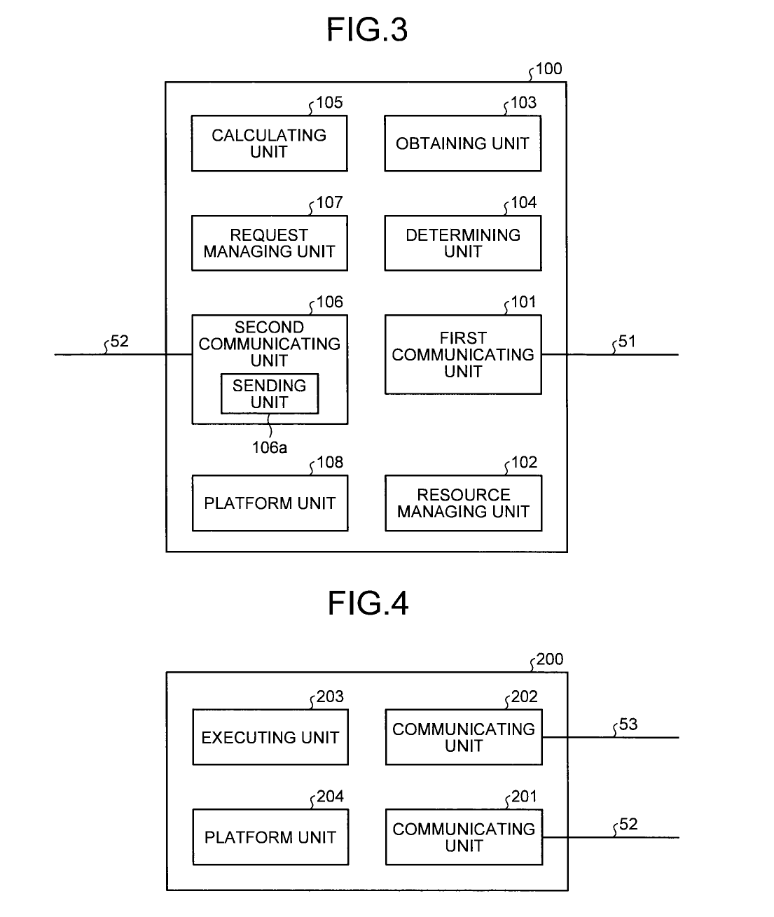

FIG. 3 is a block diagram illustrating a configuration example of the node 100. As illustrated in FIG. 3, the node 100 includes a first communicating unit 101, a resource managing unit 102, an obtaining unit 103, a determining unit 104, a calculating unit 105, a second communicating unit 106, a request managing unit 107, and a platform unit 108.

The first communicating unit 101 implements the quantum cryptographic communication technology to generate and share a random number with a different node 100 (external device) (hereinafter, also referred to as “an opposite node”) that is connected by a communication link 51 (an internode link); and manages the generated random number as a link key. Moreover, the first communicating unit 101 is used in communicating data with the different node 100 that is connected via an internode link (i.e., used in performing internode data communication).

Herein, as far a different node is concerned, it either can be the opposite node connected directly by a link or can be a still different node connected via a different internode link of the opposite node. In the latter case, the first communicating unit 101 can be equipped with a routing function for performing communication via a plurality of nodes in the cryptographic communication network. The data communicated among the nodes via the first communicating unit 101 represents, for example, application key data. Such internode communication of data can be performed in an encrypted form using the link keys managed by the nodes 100.

The resource managing unit 102 manages and holds the link keys and the application keys that are exchanged via the first communicating unit 101. As far as the link keys are concerned, the resource managing unit 102 holds only such link keys which are exchanged between the directly-connected opposite nodes. As far as the application keys are concerned, the resource managing unit 102 can hold and manage the application keys that are exchanged between any two nodes 100 present in the cryptographic communication network.

Moreover, generally, a link key is used for the purpose of enabling safe exchange of application keys between the nodes 100. Each link key that has been used is destroyed. An application key is sent from the node 100 to the application 200 by means of a method described later, and is used by that application 200. Once an application key is provided to the application 200, the application key is usually destroyed in the node 100. The keys that are held and managed by the resource managing unit 102 represent one of the most important data for security reasons in the cryptographic communication system. For that reason, depending on the file system or the operating system (OS); security measures such as encryption, anti-tampering, and access restriction can be taken. Although there are various methods to implement the resource managing unit 102; it can be implemented as, for example, a file system or a database.

The obtaining unit 103 performs the operations (A1) and (A2) mentioned above. That is, the obtaining unit 103 obtains (gathers) the key resource information of the application keys that can be provided by the other nodes 100. Moreover, the obtaining unit 103 obtains (gathers) the information regarding the other applications 200 other than the application 200 that requests for the key resource information (i.e., obtains other application information). In order to gather the key resource information and the other application information, the obtaining unit 103 can perform communication with the other nodes 100 using the first communicating unit 101 or using some other communication interface (not illustrated).

The determining unit 104 performs the operation (A3) mentioned above. That is, the determining unit 104 examines the path candidates (route candidates) from the corresponding node 100 to the other nodes 100 in the cryptographic communication network.

The calculating unit 105 refers to the key resource information obtained by the obtaining unit 103 and calculates key resource information that can be provided to the application 200 which has requested for the key resource information. At that time, from among the path candidates determined by the determining unit 104, the calculating unit 105 calculates the path through which the largest key resource can be provided (i.e., calculates the most suitable path). Then, as the key resource information that can be provided to the application 200, the calculating unit 105 calculates the key resource information that can be provided using the most suitable path.

The second communicating unit 106 is used in performing data communication with the application 200 that is connected by a communication link (an application communication link). For example, the second communicating unit 106 receives an application key acquisition request from the application 200, and accordingly provides application keys to the application 200. Moreover, the second communication unit 106 is also used in communication for receiving key resource query information and sending back the key resource information.

The second communicating unit 106 includes a sending unit 106a that sends a variety of data to the application 200. For example, the sending unit 106a sends the key resource information, which is calculated by the calculating unit 105, to the application 200.

The request managing unit 107 receives and manages the key resource information that is requested by the application 200, as well as manages and notifies the key resource information that is allotted to the application 200. For example, the request managing unit 107 manages the key resource information by maintaining a database in which the identifier (such as the address) of the application 200 is stored in a corresponding manner to the key resource information requested by that application 200.

The request managing unit 107 makes use of the second communicating unit 106 to perform communication with the application 200. The request managing unit 107 receives a request for key resource information from the application 200, and provides the key resource information at the request of the calculating unit 105. On the other hand, the calculating unit 105 notifies the request managing unit 107 about the allotted key resource information. Thus, the request managing unit 107 provides the notified key resource information to the corresponding application 200 via the second communicating unit 106.

The platform unit 108 provides operating system functionality, basic networking functionality, and security functionality of a computer that is necessary for operations and management of the other constituent elements in the node 100.

Described above was the configuration of the node 100 according to the embodiment. However, that explanation is only exemplary.

Given below is the explanation of a configuration of the application 200 according to the embodiment. FIG. 4 is a block diagram illustrating a configuration example of the application 200. As illustrated in FIG. 4, the application 200 includes a communicating unit 201, a communicating unit 202, an executing unit 203, and a platform unit 204.

The communicating unit 201 establishes a connection with the node 100 (more particularly, with the second communicating unit 106 of the node 100) via a communication link (a link 52), and communicates a variety of data with the node 100. For example, from the node 100, the communicating unit 201 obtains the application keys required to perform cryptographic communication. Apart from that, prior to starting to obtain the application keys, the communicating unit 201 sends a query about the usable key resource.

In response to a situation when the requested key resource cannot be obtained, there is no particular restriction on the operations performed by the application 200. Moreover, there is no restriction on the sequence to be followed for the communication between the application 200 and the node 100 using an internode link. However, the following method can be implemented.

For example, at the time of obtaining application keys from the node 100, the communicating unit 201 can also establish a session with the node 100. The information about that session can be shared via that node 100 to another application 200, with which the application 200 under consideration performs cryptographic communication, as well as to another node 100, with which the other application 200 is connected.

For example, when the application 200a and the application 200c perform cryptographic communication; the application 200a and the node 100a establish a key usage session therebetween, and the application 200c and the node 100c either establish an identical session therebetween or establish a correlated key usage session therebetween. Therefore, the communicating unit 201 can communicate with the node 100 using some kind of a session control protocol.

The executing unit 203 implements an application function that performs cryptographic communication. As long as communication can be performed, there is no restriction on the type of application function. For example, the executing unit 203 implements a video transmission function or a file transfer function. During cryptographic communication, the executing unit 203 communicates data using the communicating unit 202.

The communicating unit 202 provides a communication function that is necessary for the operations of the executing unit 203. Moreover, the communicating unit 202 provides the functionality for performing encryption and decryption of communication data. Upon receiving transmit data from the application 200, the communicating unit 202 encrypts the transmit data and sends the encrypted data via a data communication link (a link 53). Moreover, upon receiving data from a cryptographic communication link, the communicating unit 202 decrypts the received data and sends the decrypted data to the executing unit 203.

In case it becomes necessary to use application keys during data encryption and data decryption, the communicating unit 202 requests for new application keys via an internode link. Meanwhile, the communicating unit 202 can perform cryptographic communication by implementing any encryption algorithm. For example, a Vernam cipher such as the one-time pad can be used or a block cipher such as the advanced encryption standard (AES) can be used. Moreover, apart from encryption, it is also possible to perform message authentication. However, it is assumed that at least one of the encryption algorithms used by the communicating unit 202 makes use of the application keys provided by the node 100.

The platform unit 204 provides operating system functionality, basic networking functionality, and security functionality of a computer that is necessary for operations and management of the other constituent elements in the application 200.

Described above was the configuration of the application 200 according to the embodiment. However, that explanation is only exemplary.

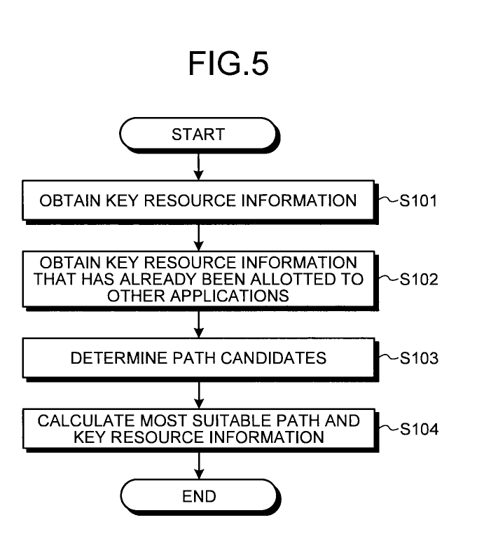

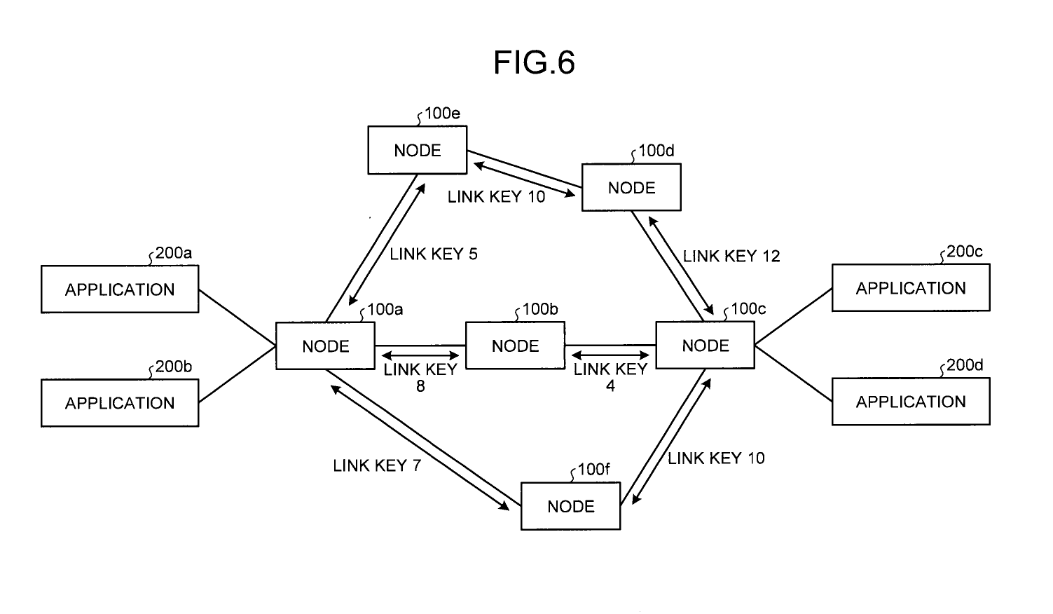

Given below is the explanation of a key resource calculation operation performed in the communication system configured in the abovementioned manner according to the embodiment. FIG. 5 is a flowchart for explaining a key resource calculation operation according to the embodiment. FIG. 6 is a diagram illustrating a network configuration example of the communication system.

Firstly, the explanation is given for a case in which the key generation speed is treated as the key resource information. FIG. 6 illustrates an example in which the key generation speed is treated as the key resource information. In FIG. 6, “link key n” indicates that “n” is the key generation speed of link keys in the corresponding link. The key generation speed of link keys can be determined according to, for example, the method, the quantum communication throughput, the optical fiber cable length, and the loss rate in quantum cryptographic communication. The key generation speed of link keys is obtained by, for example, the first communicating unit 101. Moreover, the key generation speed of link keys can be considered to be fixed during system operations or can be considered to be dynamically variable during system operations.

According to the sequence illustrated in FIG. 5, the node 100 refers to the gathered information such as the key generation speed of link keys, calculates the key generation speed of application keys, and sends the calculated key generation speed to the application 200. Meanwhile, Step S101 to Step S104 respectively correspond to the operations (A1) to (A4) mentioned above.

Firstly, the obtaining unit 103 gathers information about the key generation speed of link keys in the paths between all nodes 100 that are present in the cryptographic communication network (Step S101). For example, the obtaining unit 103 performs the operation at Step S101 by performing some kind of internode communication at a fixed time interval. The operation at Step S101 can be performed in advance prior to receiving a query from the application 200 or can be performed after receiving a query from the application 200. Moreover, the operation at Step S101 can be performed regardless of receiving a query from the application 200.

There are various methods for gathering the key generation speed of link keys. Each node 100 can notify a management server (management device) (not illustrated) about key generation speed information of link keys in the links retained by that node 100; and then can obtain the necessary key generation speed information of link keys from the management server. Herein, the management server points to a server that, for example, gathers and manages the key generation speed information of link keys of all the nodes 100. In this case, the obtaining unit 103 can perform communication with the management server. Such a management server can be implemented using a simple database or using a directory server. When the management server is present in the cryptographic communication network, each node 100 can communicate with the management server via the corresponding first communicating unit 101. On the other hand, when the management server is present in a different network, each node 100 can communicate with the management server via a different network interface (not illustrated).

As another method, each node can individually communicate with the corresponding previous node and obtain the key generation speed information of link keys of all links. Alternatively, using message switching of a routing protocol, each node 100 can gather the key generation speed information of link keys retained by all other nodes 100 as one of the parameters in the routing protocol. Herein, the routing protocol points to a protocol that is implemented while establishing routing in the cryptographic communication network.

As a routing protocol that can be used for this purpose; the OSPF protocol (OSPF stands for Open Shortest Path First) is available. In the OSPF protocol, link state update (LSU) packets are exchanged among all nodes in the communication system so as to exchange cost information of each path (link) that is the necessary metric in the routing protocol. Herein, the key generation speed information of link keys can be exchanged as a type of the cost. With that, the operation at Step S101 can be performed. In this case, for example, the configuration can be such that the obtaining unit 103 and the first communicating unit 101 implement the routing protocol.

The key generation speed information of link keys that is gathered is held in the obtaining unit 103. Herein, with reference to FIG. 6, the key generation speed information of link keys points to, for example, the number mentioned in each link (i.e., points to “n” in each link). In the example illustrated in FIG. 6, the key generation speed information of link keys is held in the following manner.
between the node 100a and the node 100e: 5
between the node 100e and the node 100d: 10
between the node 100d and the node 100c: 12
between the node 100a and the node 100b: 8
between the node 100b and the node 100c: 4
between the node 100a and the node 100f: 7
between the node 100f and the node 100c: 10

Returning to the explanation with reference to FIG. 5, the obtaining unit 103 further gathers the information of other applications (Step S102). In the cryptographic communication network, the operation at Step S102 becomes necessary in the case of executing a plurality of applications 200 at the same time. In the case of executing only a single application at a time, the operation at Step S102 is not necessary and can be skipped.

For example, consider a case in which the application 200a that is connected to the node 100a sends a query to the node 100a about the key resource required for communicating with the application 200c that is connected to the node 100c. Moreover, it is assumed that an application 200b that is also connected to the node 100a has already used (allotted) some of the key resource (the key generation speed) required for cryptographic communication with an application 200d that is also connected to the node 100c. In this case, it is not possible to use the key resource (the key generation speed) which has been allotted for the cryptographic communication between the application 200b and the application 200d. For that reason, the key resource (key generation speed) that the application 200a can obtain from the node 100a decreases in amount as compared to the case in which cryptographic communication is not performed between the application 200b and the application 200d.

Thus, it is necessary to take into account the presence of other applications 200 which share the key resource, and it is necessary to think that the usable key resource (the key generation speed of application keys) for the application 200a is the remaining key resource that remains after deducting the key resource (the key generation speed) used by the other applications 200.

For that reason, the obtaining unit 103 performs operations according to either one of a first countermeasure and a second countermeasure given below.

### First Countermeasure

In the operation (A1) (at Step S101); the obtaining unit 103 gathers, from the node 100, the key resource that is available after deducting the key resource already allotted to the other applications 200. In this case, for example, the node 100 is configured to provide, to the obtaining unit 103, the key resource that is available after deducting the key resource already allotted to the other applications 200. With that, in the operation (A2) (at Step S102), there is no need to take any particular measures. In each node 100, the obtaining unit 103 holds the variety of information, which is obtained from the corresponding first communicating unit 101, in a sharable manner.

However, there is a possibility that the application key allotment performed with respect to the other applications 200 undergoes a significant change in status. Hence, in order to accurately carry out the operation at Step S102 using the first countermeasure, it is necessary to perform the operation at Step S102 in fine-grain manner (in short time intervals). For example, a specific countermeasure is to set short transmission intervals for the LSU packets, which are used in frequently querying a management server or which, in the OSPF protocol, are used in periodically exchanging link information.

### Second Countermeasure

In the operation (A1), information is gathered without taking into account the key resource that has already been allotted to the other applications 200. At the same time, in order to perform the operation (A2), a second management sever (not illustrated) is separately installed for the purpose of managing the usage status of the key resource. In each node 100, when the key resource is allotted to the application 200, the obtaining unit 103 notifies the second management server about the key resource allotment status. Moreover, in each node 100, the obtaining unit 103 sends a query, either periodically or as may be necessary, to the second management server about key resource allotment information in the other nodes 100. By performing this sequence of operations, each node 100 can get to know the key resource that has already been allotted to the other applications 200 (i.e., can get to know the key resource allotment information). Moreover, each node 100 can deduct the already-allotted key resource from the gathered key resource. Meanwhile, such a second management server can be implemented using a simple database or using a directory server. When the second management server is present in the cryptographic communication network, each node 100 can communicate with the second management server via the corresponding first communicating unit 101. On the other hand, when the management server is present in a different network, each node 100 can communicate with the second management server via a different network interface (not illustrated). Moreover, the second management server and the management server can be implemented either as a single server or as processes in a single server.

Subsequent to Step S101 and Step S102, the determining unit 104 determines path candidates (Step S103). For example, in a concurrent manner with Step S101 or on the basis of inter-node graph information that is gathered by implementing a separate routing protocol, the determining unit 104 examines all path candidates leading to each node 100 in the cryptographic communication network. For that, it is necessary to have the information regarding the relation of connection of each node in the network. In that regard, it is possible to use the mechanism of gathering the relation of connection using a known routing protocol. That either can be implemented concurrently with the implementation of the abovementioned routing protocol or can be performed separately.

For example, from the node 100a to the node 100c illustrated in FIG. 6, the following three path candidates are present.
Path candidate A: node 100a→node 100e→node 100d→node 100c
Path candidate B: node 100a→node 100b→node 100c
Path candidate C: node 100a→node 100f→node 100c

Meanwhile, using a condition such as not to select a path that passes through a single node twice; the determining unit 104 can be configured to eliminate redundant paths such as loop paths.

Subsequently, the calculating unit 105 calculates a path with the most suitable key resource (i.e., calculates the most suitable path) from among the path candidates, as well as calculates the key resource that can be provided via the most suitable path (Step S104). For example, regarding each path candidate that is determined, the calculating unit 105 obtains the location (link) at which the key resource value (i.e., the key generation speed of link keys) is smallest as the bottleneck of that particular path candidate. Then, as the most suitable path, the calculating unit 105 selects the path having the largest bottleneck value.

For example, for each of the path candidates A to C mentioned above, the key generation speed in bottleneck links is as given below.

### Path Candidate A:

Key generation speed between node 100a and node 100e: 5
Key generation speed between node 100e and node 100d: 10
Key generation speed between node 100d and node 100c: 12
Bottleneck value: 5

### Path Candidate B:

Key generation speed between node 100a and node 100b: 8
Key generation speed between node 100b and node 100c: 4
Bottleneck value: 4

### Path Candidate C:

Key generation speed between node 100a and node 100f: 7
Key generation speed between node 100f and node 100c: 10
Bottleneck value: 7

Therefore, the calculating unit 105 sets the path candidate C (node 100a→node 100f→node 100c) as the most suitable path. Moreover, corresponding to the most suitable path, the calculating unit 105 calculates the key generation speed as 7×α, where a represents the ratio between the key retention quantity of link keys and the key retention quantity of application keys which can be exchanged using those link keys. Ideally, a is equal to 1. With that, the key generation speed of application keys becomes equal to 7.

The node 100 sends back the calculated key generation speed to the application 200. Although there is no restriction on the operations performed by the application 200 that receives the key resource information, the following operations can be performed for example. The application 200 requests the node 100 to provide the key resource of the most suitable path. In response to that request, the node 100 obtains the application keys from the most suitable path and sends it to the application 200. Subsequently, the application 200 makes use of the received application keys and starts performing cryptographic communication in which application keys are used.

Meanwhile, for example, the calculating unit 105 can perform the operations at Step S103 and Step S105 as a single operation. Moreover, the path that is selected as the most suitable path can be (P1) a single path or (P2) a path that gets divided into a plurality of paths along the way (thus, a plurality of paths are used at the same time and a greater amount of key resource is used at once). In the example given above, the explanation is given for the case of (P1).

Generally, in the case of (P2), the abovementioned operations can be performed by resolving the maximum flow problem, which points to the mathematical problem of obtaining the maximum flow in a flow network from a single start point to a single end point. As far as resolving the maximum flow problem is concerned, various solutions such as linear programming and the Ford-Fulkerson algorithm are known. The calculating unit 105 can implement any of those algorithms to perform the operations mentioned above.

In the case of (P1) too, it is possible to implement various methods. The calculating unit 105 can implement any of those algorithms to perform the operations mentioned above. Alternatively, (P1) can be resolved as part of the maximum flow problem. For example, the Dijkstra's algorithm that is known as the algorithm for solving the shortest path problem is generally implemented in the OSPF routing protocol. Thus, (P1) can also be implemented by improving that protocol. Usually, in the Dijkstra's algorithm, the total cost of each path candidate is held as the information about the destination node; and the path having the smallest total cost is selected as the shorted path. In contrast, in the improved Dijkstra's algorithm, the smallest values of costs (key resource: key generation speed) of path candidates is held; and the path having the largest of the smallest values can be selected as the most suitable path.

Described above was the sequence of operations in the key resource allotment algorithm in the case when the key generation speed is considered as the key resource. As a result of performing those operations, each node 100 can determine, with respect to each other node 100, the key generation speed as the key resource that can be provided to the application 200.

In response to a query received from the application 200; the node 100 that receives the query sends back the key resource information of the other nodes 100 from among the abovementioned key resource information.

For example, assume that the node 100a receives, from the application 200a, a query about the key generation speed as the key resource that can be used while communicating with the application 200c. In this case, the node 100a sends back the information related to the key generation speed that can be used with the node 100c.

Meanwhile, the application 200a can send the query by either specifying or not specifying the identifier (address) of the node 100c. In the case of not specifying the identifier of the node 100c, the node 100a that receives the query can identify the node 100c, which is connected to the application 200c, on the basis of the information notified by the application 200a.

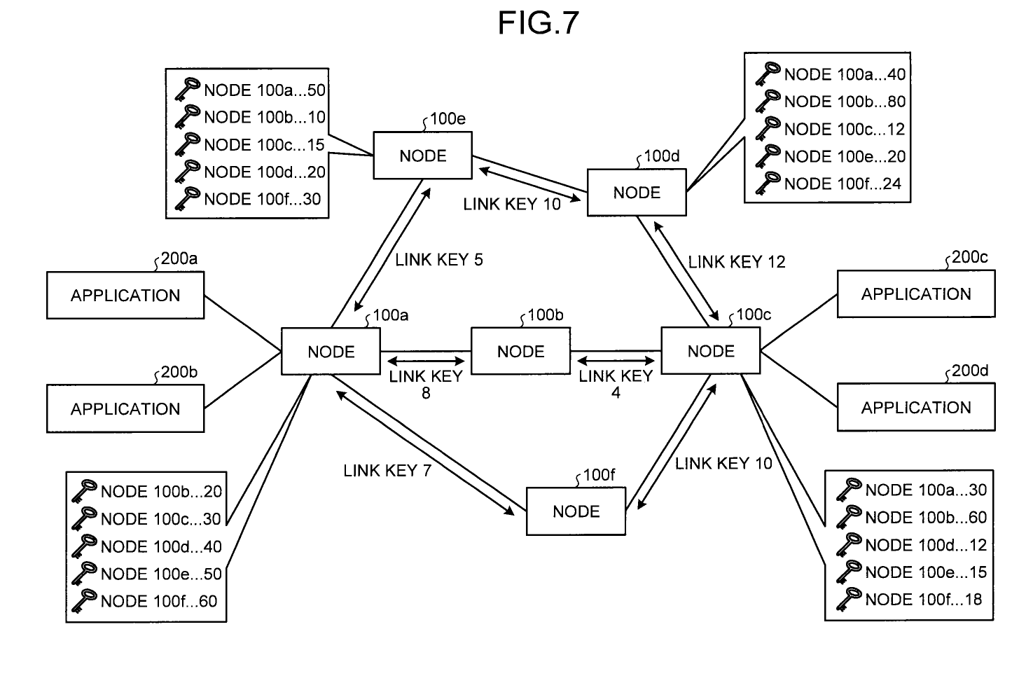

Given below is the explanation of a case in which key retention quantity is treated as the key resource. FIG. 7 is a diagram illustrating a network configuration example of the communication system in the case in which key retention quantity is treated as the key resource. In FIG. 7, “link key n” indicates that “n” is the key retention quantity of link keys in the corresponding link. Moreover, for example, with reference to FIG. 7, in the words balloon corresponding to the node 100a; “node 100b . . . 20” indicates that “20” is the key retention quantity of application keys that are shared between the node 100a and the node 100b.

Firstly, the obtaining unit 103 gathers the information about key retention quantity (Step S101). In order to count the key retention quantity, a method A or a method B given below can be implemented.

Method A: only the application keys that are already held in the corresponding node are counted in the key retention quantity

Method B: in addition to the key retention quantity counted in the method A; regarding the application keys that can be exchanged using the link keys which are already held in the links of the paths between the corresponding node and the destination node, the application keys are additionally counted in the key retention quantity as the application keys that can be additionally retained.

In the case of implementing the method A, particularly, the sequence of operations for gathering the key resource information is very simple. For example, the obtaining unit 103 can determine the key retention quantity by referring to the data of key retention quantity of application keys that is held for each node 100 by the resource managing unit 102.

In the case of implementing the method B, in addition to taking into account the key retention quantity of application keys that is held for each node 100 by the resource managing unit 102 as mentioned in the method A; it is also necessary to take into account the key retention quantity of link keys. For that reason, the obtaining unit 103 gathers the information regarding the key retention quantity of link keys in the paths between all the nodes 100 present in the cryptographic communication network.

With reference to FIG. 7, as the information required in the case of treating the key retention quantity as the key resource information, the following information is given: the key retention quantity of application keys that is held in the corresponding node 100 and shared with each of the other nodes 100 (in fact, the necessary information is only related to the corresponding node 100); and the key retention quantity of link keys of all links in the cryptographic communication network.

The key retention quantity of application keys and the key retention quantity of link keys can be obtained by accessing the resource managing unit 102. As described earlier, the key retention quantity of application keys increases by exchanging the application keys between the corresponding nodes and decreases by providing the application keys to the applications 200. Similarly, the key retention quantity of link keys increases due to the key sharing sequence in the quantum cryptographic communication technology and decreases due to the secure communication performed using link keys between nodes (for the purpose of, for example, exchanging application keys).

Given below is an example of the information held by the resource managing unit 102 of the node 100a illustrated in FIG. 7.

Firstly, given below is the key retention quantity of application keys held by each node.
Node 100b: 20
Node 100c: 30
Node 100d: 40
Node 100e: 50
Node 100f: 60

Given below is the key retention quantity of link keys held in the links between various pairs of nodes.
Links between node 100a and node 100e: 5
Links between node 100e and node 100d: 10
Links between node 100d and node 100c: 12
Links between node 100a and node 100b: 8
Links between node 100b and node 100c: 4
Links between node 100a and node 100f: 7
Links between node 100f and node 100c: 10

Meanwhile, in the case of implementing the method B, the additionally-required method of gathering the information of the key retention quantity of link keys in the paths between all nodes in the cryptographic communication network can be implemented by following the same sequence of operations as that followed while gathering the key resource information regarding the key generation speed. Hence, that explanation is not repeated.

In the case of implementing the method A, the key retention quantity of application keys that have already been allotted to the other applications 200 is stored in, for example, the request managing unit 107 or the resource managing unit 102. The obtaining unit 103 can refer to the key retention quantity that is stored and accordingly deduct the already-allotted key retention quantity (allotment information) so as to calculate the key retention quantity that can be newly provided.

In the case of implementing the method B, from among the key retention quantity of link keys, the obtaining unit 103 further gathers the information about the key retention quantity of those link keys which have already been allotted to the applications 200. In order to gather such information, it is possible to implement the same method as the method of gathering the information regarding the key generation speeds of the other applications 200.

In the case of implementing the method A, the operation performed by the determining unit 104 (at Step S103) to determine the path candidates is necessary. In the case of implementing the method B, the determining unit 104 determines the path candidates by following the same sequence of operations as that followed in calculating the path candidates related to the key generation speed.

For example, from the node 100a to the node 100c illustrated in FIG. 7, the following three path candidates are present.
Path candidate A: node 100a→node 100e→node 100d→node 100c
Path candidate B: node 100a→node 100b→node 100c
Path candidate C: node 100a→node 100f→node 100c

In the case of implementing the method A, to the application 200, the node 100 sends back, without modification, the key retention quantity of application keys corresponding to the other node 100 that is on the other side of communication.

In the case of implementing the method B, the calculating unit 105 determines the most suitable path regarding the key retention quantity by following the same sequence of operations as that followed in determining the most suitable path regarding the key generation speed. Moreover, to the application 200, the calculating unit 105 sends back, as the value of key retention quantity, the result of adding the key retention quantity of the application keys, which are obtained by implementing the method A and which are already held by the node 100, and the key retention quantity of the link keys, which are obtained by implementing the method B.

In the example illustrated in FIG. 7, there are 30 application keys that are shared between the node 100a and the node 100c. For each path candidate, the key retention quantity of link keys and the additionally-retainable application keys are as given below.

### Path Candidate A:

Key retention quantity of link keys between node 100a and node 100e: 5
Key retention quantity of link keys between node 100e and node 100d: 10
Key retention quantity of link keys between node 100d and node 100c: 12
Additionally-retainable application keys in path of path candidate A: 5×α

### Path Candidate B:

Key retention quantity of link keys between node 100a and node 100b: 8

Key retention quantity of link keys between node 100b and node 100c: 4

Additionally-retainable application keys in path of path candidate B: 4×α

### Path Candidate C:

Key retention quantity of link keys between node 100a and node 100f: 7

Key retention quantity of link keys between node 100f and node 100c: 10

Additionally-retainable application keys in path of path candidate C: 7×α

Herein, a represents the ratio between the key retention quantity of link keys and the key retention quantity of application keys which can be exchanged using those link keys. Ideally, a is equal to 1.

Thus, using the path of the path candidate C as the most suitable path, the application key retention quantity becomes equal to 37(=30+7). Then, the node 100 sends back that value (37) to the application 200.

In this way, in the communication system according to the embodiment, each node can gather key resource information such as the key generation speed or the key retention quantity, and send back allottable key resource information to an application. With that, it becomes possible for an application to obtain the information about, for example, the obtainable application keys and accordingly determine an appropriate encryption algorithm.

Meanwhile, the constituent elements of each node 100 and each application 200 can be implemented using hardware circuits or can be implemented partially or entirely using software (computer programs).

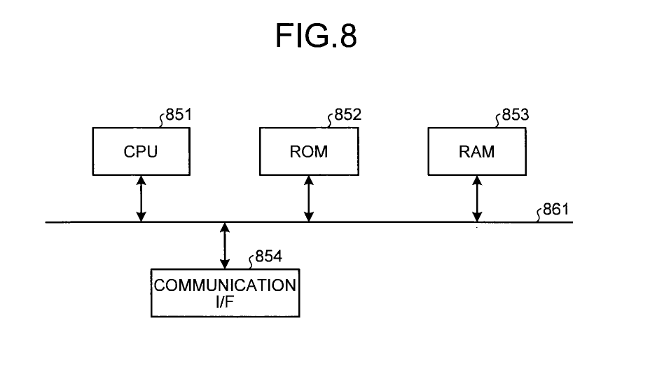

Explained below with reference to FIG. 8 is a hardware configuration of the devices (applications and nodes) according to the embodiment. FIG. 8 is an explanatory diagram for explaining a hardware configuration of the devices according to the embodiment.

Each device according to the embodiment includes a control device such as a central processing unit (CPU) 851; memory devices such as a read only memory (ROM) 852 and a random access memory (RAM) 853; a communication I/F 854 that performs communication by establishing connection with a network; and a bus 861 that interconnects the other constituent elements.

The computer programs that are executed in the devices according to the embodiment are stored in advance in the ROM 852.

Alternatively, the computer programs that are executed in the devices according to the embodiment can be recorded in the form of installable or executable files in a computer-readable recording medium such as a compact disk read only memory (CD-ROM), a flexible disk (FD), a compact disk readable (CD-R), or a digital versatile disk (DVD).

Still alternatively, the computer programs that are executed in the devices according to the embodiment can be saved as downloadable files on a computer connected to the Internet or can be made available for distribution through a network such as the Internet.

Meanwhile, the computer programs that are executed in the devices according to the embodiment contain a module for each of the abovementioned constituent elements to be implemented in a computer. In practice, for example, the CPU 851 reads the computer programs from a computer-readable memory medium and runs them such that the computer programs are loaded in a main memory device. As a result, the module for each of the abovementioned constituent elements is generated in the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Docket No.

What is claimed is:

1. A communication device that is connected to a key generating device which generates an encryption key, the communication device comprising:
an obtaining unit configured to obtain key resource information which indicates a resource of the encryption key that can be provided by the key generating device; and
a calculator configured to, based on the obtained key resource information, calculate the key resource information of the encryption key that can be provided to an application which makes use of the encryption key.

2. The device according to claim 1, wherein
the communication device is connected to a plurality of key generating devices,
the communication device further comprises a determining unit configured to determine a path which leads to a first device of the plurality of key generating devices, and
based on the obtained key resource information, the calculator calculates the key resource information of the encryption key that can be provided via the path.

3. The device according to claim 2, wherein
the determining unit determines one or more paths that lead to the first device, and
from among pieces of the key resource information that can be provided via the paths, the calculator calculates the key resource information indicating the largest value.

4. The device according to claim 3, wherein the key resource information is a generation speed of the encryption key that can be provided.

5. The device according to claim 3, wherein the key resource information is a key retention quantity of the encryption key that can be provided.

6. The device according to claim 3, further comprising a sending unit configured to send the calculated key resource information to the application.

7. The device according to claim 1, wherein the obtaining unit further obtains allotment information that indicates an already-allotted resource of the encryption key which has already been allotted by the key generating device, and
based on the obtained key resource information and the obtained allotment information, the calculator calculates the key resource information of the encryption key that can be provided to the application.

8. The device according to claim 1, wherein, from the key generating device, the obtaining unit obtains the key resource information that is included in a message exchanged according to the Open Shortest Path First routing protocol.

9. The device according to claim 1, wherein the obtaining unit obtains the key resource information from a management device that is used to store the key resource information of the key generating device.

10. A communication method implemented in a communication device that is connected to a key generating device which generates an encryption key, the communication method comprising:
obtaining key resource information which indicates a resource of the encryption key that can be provided by the key generating device; and
calculating, based on the obtained key resource information, the key resource information of the encryption key that can be provided to an application which makes use of the encryption key.

11. A communication system comprising:
a key generating device; and
a communication device, wherein
the key generating unit includes a communicating unit configured to generate an encryption key and send the encryption key to the communication device, and
the communication device includes
an obtaining unit configured to obtain key resource information which indicates a resource of the encryption key that can be provided by the key generating device; and
a calculator configured to, based on the obtained key resource information, calculate the key resource information of the encryption key that can be provided to an application which makes use of the encryption key.
